(19) United States
(12) Patent Application Publication
(10) Pub. No.: US 2020/0200922 A1
(43) Pub. Date: Jun. 25, 2020

(54) Apparatus for Measuring Ionizing Radiation

(71) Applicant: Berthold Technologies GmbH & Co. KG, Bad Wildbad (DE)

(72) Inventors: Fritz BERTHOLD, Pforzheim (DE); Juergen BRIGGMANN, Ammerbuch (DE); Ewald FREIBURGER, Neulingen (DE); Wilfried REUTER, Straubenhardt (DE)

(21) Appl. No.: 16/720,155

(22) Filed: Dec. 19, 2019

(30) Foreign Application Priority Data
Dec. 21, 2018 (EP) 18215444.3

(51) Int. Cl. G01T 1/185; H01J 47/02; H01J 47/06; G01T 1/18; G01T 1/29

(52) U.S. Cl. CPC G01T 1/185; H01J 47/026; G01T 1/2935; G01T 1/18; H01J 47/067; H01J 47/062

(57) ABSTRACT

An apparatus for measuring ionizing radiation includes a detector having a cathode, an anode, a counting gas between the cathode and the anode for generating gas ionization by ionizing radiation, a voltage source for applying a voltage between the cathode and the anode, and a current measuring device for measuring a detector current between the cathode and the anode. The detector current is generated in the counting gas by the ionizing radiation. The apparatus further includes a setting device, wherein the setting device is configured for independently setting the apparatus into different operating modes depending on the measured detector current, and/or wherein the setting device is configured for independently setting the apparatus into different measurement ranges depending on the measured detector current.

### CROSS REFERENCE TO RELATED APPLICATION

This application claims priority under 35 U.S.C. § 119 from European Patent Application No. 18215444.3, filed Dec. 21, 2018, the entire disclosure of which is herein expressly incorporated by reference.

### BACKGROUND AND SUMMARY OF THE INVENTION

The invention relates to an apparatus for measuring ionizing radiation.

Apparatuses for measuring ionizing radiation are known.

The problem addressed by the invention is that of providing an apparatus for measuring ionizing radiation which has improved properties compared with the prior art, in particular enables a simple and thus cost-effective construction and at the same time, in particular flexible and/or safe, operation depending on the intensity of the ionizing radiation.

The apparatus according to the invention is configured for, in particular independently or automatically, measuring ionizing radiation. The apparatus comprises a detector for ionizing radiation and an, in particular electronic, operating mode setting device. The detector comprises a cathode device, an anode device, a counting gas, an, in particular electrical, voltage source and an, in particular electronic, current measuring device. The counting gas is situated such that it is spatially arranged and/or configured between the cathode device and the anode device for generating free charge carriers, in particular electrons and positive ions, by gas ionization by the incident, ionizing radiation. The voltage source is configured for, in particular independently or automatically, applying an, in particular electrical, voltage, in particular a DC voltage, between the cathode device and the anode device. The current measuring device is configured for, in particular independently or automatically, measuring a detector current between the cathode device and the anode device, said detector current being caused by ionization. The operating mode setting device is configured for independently or automatically setting the apparatus into a first operating mode and into one or more operating modes different than the first operating mode depending on the measured detector current.

The apparatus, in particular its operating mode setting device, enables, in particular flexible and/or safe, operation, in particular without user actuation and/or operation, depending on the ionizing radiation, in particular a radiation intensity of the ionizing radiation, with the one detector. This enables a simple and thus cost-effective construction of the apparatus.

With the apparatus according to the invention, a single detector achieves a very large dynamic range such as has hitherto been able to be achieved with only a plurality of detectors according to the prior art.

The apparatus is configured such that it can simultaneously measure alpha radiation, beta radiation, gamma and/or X-ray radiation and/or neutron radiation.

Further additionally or alternatively, the cathode device can comprise just a single cathode. In other words, the cathode device need not or may not comprise a plurality of cathodes.

Further additionally or alternatively, the anode device can comprise just a single anode or a plurality of anodes, in particular anodes electrically connected in parallel. In particular, the anode device can comprise at least one anode wire.

Further additionally or alternatively, the detector can be referred as a gas-filled detector. Further additionally or alternatively, the counting gas can comprise or be argon, methane, CO2 and/or isobutane and/or air-equivalent gas.

The ionizing radiation generates free charge carriers in the gas. In an ionization chamber, this current corresponds to the current flowing from the detector, the detector current. In the case of a proportional counter, the primarily generated ionization current is amplified by gas gain and thus increases the detector current by the so-called gas gain factor. The measurement sensitivity is significantly increased by this gas gain.

An apparatus according to the invention without gas gain is referred to as an ionization chamber. In the case of operation with gas gain, this is referred to as counting tube.

In the case of gas-filled detectors, a distinction is drawn between ionization chambers, proportional counting tubes and Geiger-Muller counting tubes. Geiger-Muller counting tubes will not be considered here.

Gas-filled detectors can be operated in various operating modes, referred to hereafter as B1-B4.

1. Ionization chamber with gas gain (identical to proportional counting tube with current measurement) (B1)

2. Ionization chamber without gas gain (B2)

3. Proportional counting tube, operation with integral discriminator and standard pulse output, high-voltage setting at the plateau (B3)

4. Proportional counting tube with pulse height measurement (B4)

According to the invention, the instances of switching between the operating modes or the measurement ranges within the operating mode B1 are triggered solely by the measured detector current.

One application of the invention relates to the use of such detectors for dose power measurement. Here the present invention proceeds from the measurement of the detector current with or without gas gain. In this case, the major advantage of current measurement with gas gain resides in the high measurement sensitivity combined with a large dynamic range. If the gas gain factor is n, then the detector current is higher by the same factor n than in the case of operation without gas gain.

However, this is associated with disadvantages:

1. The measurement ranges contributing to the dynamic range have to be calibrated.

2. Compared with an ionization chamber, the current measurement is significantly more sensitive to alteration of the operating point for example as a result of temperature change, change in the gas gain or aging.

The invention overcomes the outlined disadvantages of the prior art.

For this purpose, various measurement ranges are preconfigured (calibrated). The optimum measurement range is then selected automatically by way of the measured detector current.

This preconfiguration can be carried out in the following way:

A radioactive reference source in a defined position with respect to the detector generates a detector current in the detector.

Calibration:

In order to set the operating point, in the presence of the reference source, the high voltage can be altered step by step or continuously and (at the same time) in the process the electronic gain can be adapted or readjusted in such a way that a chosen reference current remains constant. Likewise, the electronic gain can be altered step by step or continuously and the high voltage can be altered or readjusted in such a way that a chosen reference current remains constant. The functional relationship ascertained here between electronic gain and high voltage is stored (as a list or curve). As many calibrated measurement ranges as desired are obtained with this method. (The limit stems from the fact that, with the reference source definitely not overdosed, the detector current always has a greater inaccuracy at low high-voltage values, that is to say low gas gain.)

Measurement: During the actual measurement, a gain value is preferably selected from the list, and the high-voltage value associated therewith is automatically set and the measurement sensitivity is altered by the factor of the electronic gain relative to the original value of the gain (in relation to a reference value), i.e. this gain value corresponds to a sensitivity value that could alternatively be taken from the list and input. Of course, the high-voltage value could also be input and the electronic gain would be automatically readjusted. During the measurement, a sensitivity is then chosen automatically depending on the measured detector current.

The highest possible gas gain is advantageously employed in order to obtain an optimum signal-to-noise ratio. On the other hand, the gas gain must not become so high that the actual proportional range is left. The reduction of the gas gain for measurement range switching is effected in order to avoid overload effects of the counting tube at high radiation intensity.

The statements given above are analogously applicable if a reference spectrum or a variable derived therefrom is used instead of the reference current. During the calibration with the aid of suitable properties of a reference spectrum, in contrast to the use of the reference current, there is no need to carry out decay compensation owing to the radioactive decay of the reference emitter in accordance with the half-life of the radioisotope used.

Further additionally or alternatively, the apparatus can be referred to as a measuring instrument, in particular as a radiation protection measuring instrument. Further additionally or alternatively, the apparatus can be used or applied in the field of radiation protection.

In one development of the invention, the operating mode setting device is configured for independently setting the apparatus, in particular from one measurement range of the first operating mode into another measurement range of the first operating mode or into the second operating mode upon a current limit value being reached or exceeded by the measured detector current. Additionally or alternatively, the operating mode setting device is configured for independently setting the apparatus, in particular from the second operating mode B2, into a measurement range of the first operating mode B1 in the event of the detector current falling below a second current limit value.

In order to avoid excessively frequent switching between the measurement ranges or operating modes, a hysteresis can be provided.

The apparatus thus enables a high measurement sensitivity with a large dynamic measurement range and overload resilience and thus flexible and safe operation.

In particular, the first voltage value can be such that the apparatus can operate in the proportional range. In detail, in the proportional range, although the apparatus cannot enable a measurement of a high radiation intensity, it can enable a measurement with a high sensitivity.

Additionally or alternatively, the second voltage value can be such that the apparatus can operate as an ionization chamber. In detail, as an ionization chamber, although the apparatus cannot enable a measurement with a high sensitivity, it can enable a measurement of a high radiation intensity.

Further additionally or alternatively, the operating mode setting device can be configured for independently setting, in particular step by step or in stages, the voltage source to a minimum voltage value, in particular without gas gain, to a maximum voltage value with maximum gas gain and/or to at least one medium voltage value between the minimum voltage value or the maximum voltage value depending on the measured detector current. In particular, a medium voltage value can be lower than the maximum voltage value or a possible next higher medium voltage value in such a way that a medium gas gain can be lower than the maximum gas gain or a possible next higher medium gas gain by a factor of 5-20, in particular 10. The detector or the apparatus can thus enable a large dynamic measurement range with a good measurement resolution or measurement sensitivity or a plurality of measurement ranges in each case with a suitable measurement resolution or measurement sensitivity.

Further additionally or alternatively, the operating mode setting device can be configured for independently setting the voltage source to the second voltage value, in particular from the first voltage value, in the event of the first current limit value being reached or exceeded by the measured detector current, in particular in the case of the first voltage value. Additionally or alternatively, the operating mode setting device can be configured for independently setting the voltage source to the first voltage value, in particular from the second voltage value, in the event of the measured detector current falling below the second current limit value, in particular in the case of the second voltage value.

Upon transition from B1 to B2, the high voltage has to be reduced at least to an extent such that gas gain no longer occurs. However, the risk of great space charge formation and recombination is all the higher, the lower the voltage. According to the invention, the ionization current can be measured upon polarity reversal between anode and cathode, i.e. the counting wire(s) is/are the cathode and the counting tube wall is the anode.

In this configuration, gas gain cannot occur even at high voltages since the electrons passing toward the wall cannot trigger gas multiplication, i.e. the result is ionization chamber operation at high voltages with minimal risk of recombination. The dynamic range is thus increased toward high radiation intensities. This is also applicable in particular to the measurement of pulsed radiation.

In one development of the invention, the apparatus comprises an, in particular electrical, current pulse measuring device and an, in particular the and/or electrical, determining device. The current pulse measuring device is configured for, in particular independently or automatically, measuring heights, in particular height values of the heights, of ionization current pulses between the cathode device and the anode device and/or signal current pulses based on the ionization current pulses. The determining device is configured for, in particular independently or automatically, determining a, in particular the, property, in particular a property value of the property, of the ionizing radiation on the basis of a spectrum of the measured heights of the detector current pulses.

Additionally or alternatively, determining the property on the basis of the measured counting rate of the detector current pulses can be referred to as counting rate determining operation. In particular, in counting rate determining operation, all detector current pulses that are above a predefined or determined pulse height threshold value can be digitally evaluated or counted. Further additionally or alternatively, in counting rate determining operation it is possible to choose a suitable operating point voltage, in particular a suitable operating point voltage value of the operating point voltage, at the plateau of the detector.

In particular, the property can comprise or be the counting rate, the activity, in particular in becquerels, an area contamination, in particular in becquerels per square centimeter, and/or a, in particular the, dose power.

Further additionally or alternatively, determining the property on the basis of the spectrum of the measured heights of the detector current pulses can be referred to as spectrum determining operation.

Further additionally or alternatively, during operation with gas gain, in particular during proportional range operation, it is possible to determine the property on the basis of the measured counting rate and/or the spectrum of the measured heights of the detector current pulses.

Further additionally or alternatively, the apparatus can comprise an, in particular the, electronic amplification device, wherein the electronic amplification device can be configured for amplifying the detector current pulses.

Further additionally or alternatively, the detector current can be averaged temporally or not resolved temporally. Further additionally or alternatively, detector current pulses can be, in particular in each case, resolved temporally or not averaged temporally.

Further additionally or alternatively, during counting rate determining operation and/or during spectrum determining operation, the parallel measurement of the detector current can be referred to as current concomitant measurement.

In one embodiment of the invention, the operating mode setting device is configured for independently or automatically setting the determining device for determining the property of the ionizing radiation in the first operating mode on the basis of the measured detector current and in the third operating mode on the basis of the measured counting rate and/or the spectrum of the measured heights of the detector current pulses depending on the detector current.

The apparatus thus enables a high measurement sensitivity with a large dynamic measurement range and overload resilience and thus flexible and safe operation.

In detail, during current determining operation, compared with counting rate determining operation and/or spectrum determining operation, although the apparatus can enable a measurement with a lower sensitivity, in return it can enable a measurement of a higher radiation intensity. In particular, during counting rate determining operation and/or during spectrum determining operation at a high radiation intensity, particularly if the ionizing radiation can be pulsed, the determining device can be overloaded rapidly, specifically more rapidly than during current determining operation. In particular, dead time losses or coincidence losses can occur at a high radiation intensity. This can have the consequence that during counting rate determining operation and/or during spectrum determining operation in the case of a strong, in particular rising, radiation field, the determined property value can decrease or an excessively low property value or even a property value equal to zero can be determined. By contrast, the measured detector current, in particular always, can rise monotonically or at least tend toward a saturation value, but in particular not decrease.

In particular, the operating mode setting device can be configured for independently setting the determining device, in particular from counting rate determining operation and/or spectrum determining operation, in particular during operation with gas gain, in particular during proportional range operation, to current determining operation, in particular during operation with gas gain, in particular during proportional range operation, or during operation without gas gain, in particular during ionization chamber operation, in the event of the first current limit value being reached or exceeded by the measured detector current. Additionally or alternatively, the operating mode setting device can be configured for independently setting the determining device, in particular from current determining operation, in particular during operation with gas gain, in particular during proportional range operation, or during operation without gas gain, in particular during ionization chamber operation, to counting rate determining operation and/or spectrum determining operation, in particular during operation with gas gain, in particular during proportional range operation, in the event of the measured detector current falling below the second current limit value.

In one development of the invention, the apparatus comprises a pulse height measurement of the detector current pulses (B4). This allows a pulse height spectrum to be recorded. There are the following applications for this in the context of the invention:

The first application is the calibration of the operating point for the operating mode B1. By readjusting the high voltage, the operating point is set by the variation of the high voltage so as to attain a reference spectrum or properties of the spectrum that are relevant to the operating point in the presence of the reference emitter.

Another application serves for determining the dose power by varying weighting of individual spectrum ranges, e.g. for determining the dose power in accordance with customary standards, for example H*10 or H′0.07.

The apparatus according to the invention can serve for measuring either continuous or pulsed radiation.

As described above, in the case of pulsed radiation, the counting rate can decrease while the ionization current and/or signal current can rise.

Additionally or alternatively, all detector current pulses that are above a predefined or determined pulse height threshold value can be digitally evaluated or counted (operating mode B3). Further additionally or alternatively, it is possible to choose a suitable operating point voltage, in particular a suitable operating point voltage value of the operating point voltage, at the plateau of the detector.

In the operating mode B3, a simultaneous measurement of the detector current can be effected as current concomitant measurement. This current concomitant measurement can firstly trigger an alarm signal at high counting rates if the counting rates can no longer be measured correctly owing to counting rate losses. In order to extend the measurement range, the detector current itself can be used as a measurement variable. (Automatic switching from the operating mode B3 to the operating mode B1 by means of the current concomitant measurement.)

Further additionally or alternatively, during operation with gas gain, in particular during proportional range operation, it is possible to determine the property on the basis of the comparison.

Further additionally or alternatively, the apparatus can comprise an, in particular the, electronic amplification device, wherein the electronic amplification device can be configured for amplifying the detector current pulses.

Further additionally or alternatively, the detector current can be averaged temporally or not resolved temporally. Further additionally or alternatively, detector current pulses, in particular in each case, can be resolved temporally or not averaged temporally.

In one development of the invention, the voltage source is an, in particular the, settable voltage source for applying an, in particular the, settable voltage between the cathode device and the anode device. The apparatus comprises an, in particular electrical, operating point setting device having a reference source emitting ionizing reference radiation. The operating point setting device is configured for independently or automatically setting the voltage source to an operating point voltage value in such a way that the detector current measured by the ionizing reference radiation reaches or has a predefined or defined reference current value, in particular during operation with gas gain, in particular during proportional range operation.

The apparatus thus enables an accurate measurement of the radiation property, in particular during operation with gas gain, in particular during proportional range operation.

In particular, during operation with gas gain, in particular during proportional range operation, the gas gain can vary greatly on account of various influences such as aging, counting gas loss or temperature fluctuations.

Additionally or alternatively, the apparatus can comprise a compensation of the decrease in the radiation intensity as a result of decay of the radioactive reference source. This decay compensation is only required if the operating point setting is carried out by way of the measurement of the reference current. In the case where the operating point is set by way of spectrum measurement, a compensation is not required since the spectrum form is maintained even in the event of a decrease in the activity of the reference source. Positioning errors of the reference source would not have an effect during the spectrum determination in contrast to determining the operating point by way of current measurement. Further additionally or alternatively, the apparatus can be configured for a defined detector-reference source geometry. Further additionally or alternatively, the apparatus can be configured for shielding ambient radiation.

Additionally or alternatively, during the calibration process, the property of the spectrum can be an integral over the spectrum. Further additionally or alternatively, the property of the spectrum can be a spectrum form. Further additionally or alternatively, the property of the spectrum can be a position of a maximum in the spectrum. Further additionally, the property of the spectrum can be a ratio of spectrum components. In particular, this can be referred to as ratio regulation.

Further additionally or alternatively, the apparatus can comprise an analog-to-digital converter (ADC) and/or a field programmable gate array (FPGA), wherein the FPGA can be configured in particular for evaluating an expected spectrum form. The detector or the apparatus thus enables a large dynamic and calibrated measurement range with a good measurement resolution or measurement sensitivity or a plurality of measurement ranges in each case with a suitable measurement resolution or measurement sensitivity.

Additionally or alternatively, the operating point setting device can comprise just a single reference source. In other words: the operating point setting device need not or may not comprise a plurality of reference sources. Further additionally or alternatively, the apparatus need not or may not be configured for a plurality of defined detector-reference source geometries, if indeed for just a single detector-reference source geometry. This can enable a simple and thus cost-effective construction of the apparatus.

In one embodiment of the invention, the reference source is sodium-22 or iron-55 or some other suitable isotope. In particular, sodium-22 and/or iron-55, in particular in each case, have/has a biologically very short half-life and thus a very high legal release limit. Consequently, the reference source may indeed have a high activity, but below the legal release limit. This can enable cost-effective transport of the apparatus.

In one development of the invention, the apparatus comprises a drivable, in particular electrical, alarm signal output device. The alarm signal output device is configured for, in particular independently or automatically, outputting in the event of the detector current limit value of an, in particular acoustic and/or optical, alarm signal being exceeded. The operating mode setting device is configured for independently or automatically driving the alarm signal output device for outputting the alarm signal in each operating mode.

The apparatus, in particular the alarm signal output device, thus enables a notification, particularly if the determining device exhibits overload (or overflow).

In one development of the invention, the cathode device is configured to be at ground potential during operation, or the cathode device is at ground potential during operation. The anode device is configured to be at a positive potential relative to ground potential during operation, or the anode device is at the positive potential during operation.

The apparatus thus enables the user to be protected against touching mechanical components connected to voltage, and/or shielding of the anode device.

In particular, the cathode device can spatially surround the anode device.

In one development of the invention, the cathode device partly or completely consists of carbon fibers.

The cathode can also consist of some other suitable material such as e.g. metal or plastic. If the latter is not electrically conductive, the surface facing the anode is coated with a conductive layer.

Preferably, the cathode device is composed of a tissue equivalent or at least air equivalent material. The transmissivity of the counting tube body for low-energy x-ray or gamma radiation is all the higher, the lower the atomic number of the material used.

The apparatus, in particular the detector, in particular the cathode device, thus enables a high mechanical stability. In addition, the apparatus, in particular the detector, can be impermeable to the counting gas and/or transmissive for the ionizing radiation, in particular for low-energy ionizing radiation, and/or enable a low energy dependence.

In one development of the invention, the detector comprises, in particular either, a cylindrical counting tube or a large-area counter.

In particular, the counting tube can comprise just a single anode wire. Additionally or alternatively, the large-area counter can comprise a plurality of anode wires, in particular arranged such that they run parallel.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an apparatus according to an embodiment of the invention for measuring ionizing radiation.

FIG. 2A shows a cross section of a cylindrical counting tube of a detector of the apparatus from FIG. 1.

FIG. 2B shows a cross section of a large-area counter of a detector of the apparatus from FIG. 1.

FIG. 3 shows a block diagram of the apparatus from FIG. 1.

FIG. 4 shows current-voltage characteristic curves of the apparatus from FIG. 1 for various dose powers.

FIG. 5 shows a spectrum of heights of detector current pulses measured by means of the apparatus from FIG. 1.

### DETAILED DESCRIPTION OF THE DRAWINGS

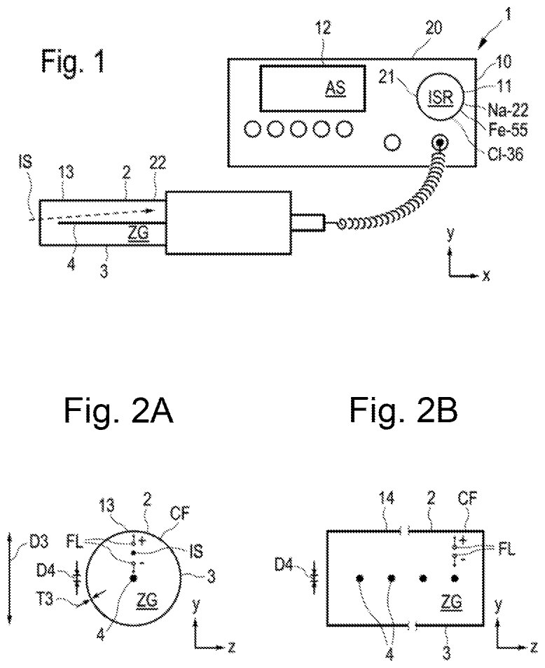

FIGS. 1 to 3 show an apparatus 1 for measuring ionizing radiation IS. The apparatus 1 comprises a detector 2 and an operating mode setting device 7. The detector 2 comprises a cathode device 3, an anode device 4, a counting gas ZG, a voltage source 5 and a current measuring device 6. The counting gas ZG is situated and/or is spatially arranged and/or configured between the cathode device 3 and the anode device 4 for generating free charge carriers FL by gas ionization by the ionizing radiation IS. The voltage source 5 is configured for applying a voltage U5 between the cathode device 3 and the anode device 4. The current measuring device 6 is configured for measuring a detector current 16 between the cathode device 3 and the anode device 4. The operating mode setting device 7 is configured for independently setting the apparatus 1 into one of the operating modes B1, B2, B3 or B4 depending on the measured detector current 16 in the event of predefined limit values being exceeded or undershot, optionally with hysteresis.

Furthermore, the voltage source 5 is a settable voltage source for applying a settable voltage U5 between the cathode device 3 and the anode device 4.

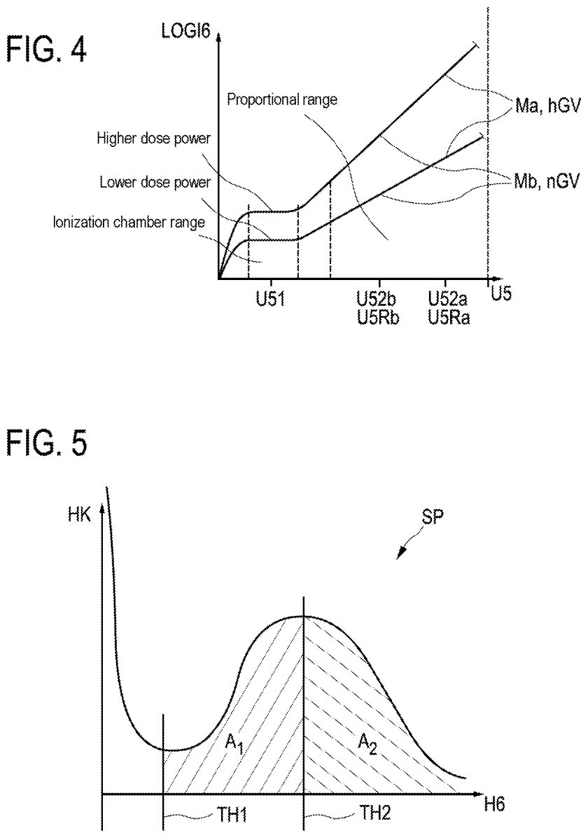

Moreover, the operating mode setting device is configured for independently setting the voltage source to different voltage values in accordance with different gas gains depending on the measured detector current, as shown in FIG. 4.

FIG. 4 shows three voltage values for ionization chamber range (U51), low (U52b) and high (U52a) gas gain. The voltage value U51 is such, in particular minimal, that the apparatus 1 without gas gain is within the ionization chamber range. In detail, the voltage U51 is in a range of 200 volts (V) to 400 V. The voltage value U52b is such that the apparatus with a low gas gain is in the proportional range. The voltage value U52a is such, in particular maximal, that the apparatus with a higher gas gain is in the proportional range. In particular, the voltage value U52b is lower than the voltage value U52a such that the lower gas gain is lower than the higher gas gain by a factor of 5-20, in particular 10. In detail, the voltage values U52b, U52a are in a range of 1000 V to 2000 V. The gas gain is in a range of up to 100 000. In alternative exemplary embodiments, there may be two voltage values or a plurality of voltage values, in particular with at least two voltage values between the minimum voltage value without gas gain in the ionization chamber range and the voltage value with maximum gas gain in the proportional range.

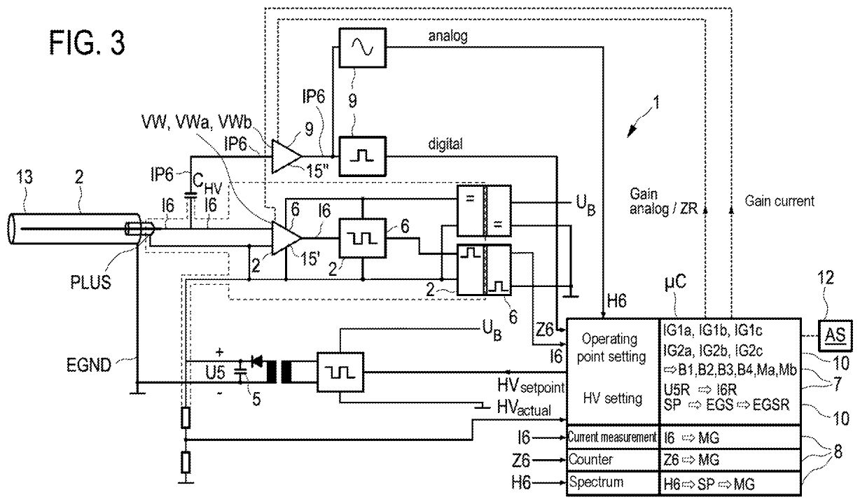

The apparatus 1 further comprises a determining device 8, as shown in FIG. 3. The determining device 8 is configured for determining a property EG of the ionizing radiation IS on the basis of the measured detector current 16.

Moreover, the apparatus 1 comprises a current pulse measuring device 9. The current pulse measuring device 9 is configured for measuring heights H6 with a downstream integral discriminator for measuring a counting rate Z6 of signal current pulses IP6 based on detector current pulses IP6 between the cathode device 3 and the anode device 4.

In addition, the determining device 8 is configured for determining an, in particular the, property EG of the ionizing radiation IS on the basis of the measured counting rate Z6 and/or a spectrum SP of the measured heights H6 of the signal current pulses IP6.

In detail, a property is the spectrum SP, which is a frequency HK of the measured heights H6, in particular of height values of the heights H6, as a function of the measured heights H6, as shown in FIG. 5.

In alternative exemplary embodiments, it may be sufficient if the determining device can be configured either for determination on the basis of the measured detector current or on the basis of the measured counting rate and/or the spectrum of the measured heights of the detector current pulses. In particular, the apparatus need not or may not comprise the current pulse measuring device.

In detail, in the exemplary embodiment shown, the operating mode setting device 7 is configured for independently setting the determining device 8 for determining the property EG of the ionizing radiation IS in the operating modes B1 and B2 on the basis of the measured detector current 16 and in the operating modes B3 and B4 on the basis of the measured counting rate Z6 and/or the spectrum SP of the measured heights H6 of the detector current pulses IP6 depending on the measured detector current 16.

In detail, there are four operating modes B1, B2, B3, B4 in the exemplary embodiment shown.

The operating mode B1 operates with gas gain with different gain factors in the proportional range for example in the case of the voltage values U52a or U52b and the property EG (e.g. dose power) is determined on the basis of the measured detector current 16.

The operating mode B2 operates without gas gain in the ionization chamber range, in particular in the case of the voltage value U51, and the property EG is determined on the basis of the measured detector current 16.

The operating mode B3 operates with the higher gas gain in the proportional range, in particular in the case of the voltage value U52a, and the property EG is determined on the basis of the measured counting rate Z6 of the detector current pulses IP6.

The operating mode B4 operates with the higher gas gain in the proportional range, in particular in the case of the voltage value U52a, and the property EG is determined on the basis of the spectrum SP of the measured heights H6 of the detector current pulses IP6.

In alternative exemplary embodiments, the apparatus, in particular the detector, need not have all the operating modes or need not be configured for all the operating modes or need not be able to be operated in all the operating modes.

The operating mode B1 operates in differently calibrated measurement ranges Ma, Mb or further ranges. If the active operating mode is for example B1, Ma (maximum sensitivity), then the apparatus can automatically switch into the measurement ranges B1, Mb . . . or into the operating mode B2.

If, in a further exemplary embodiment, the chosen operating mode is B3 or B4, then the apparatus can automatically switch into one of the measurement ranges of the operating mode B1 in the event of a predefined limit value of the detector current pulses being reached, and into the operating mode B2 in the case of even higher detector current.

Furthermore, the operating modes B2 or insensitive measurement ranges of the operating mode B1 are suitable for high radiation intensities, in particular pulsed ionizing radiation IS, but the operating modes B3, B4 are not suitable. In particular, by comparison with the operating modes B3, B4, the operating mode B2 can enable a measurement of radiation intensities higher by two orders of magnitude or a factor of 100. At low radiation intensities, in particular in the case of non-pulsed ionizing radiation IS, the operating modes B3, B4 have the highest measurement sensitivity.

Moreover, in the exemplary embodiment shown, the determining device 8 is configured for comparing the measured counting rate Z6 and/or the spectrum SP of the measured heights H6 of the detector current pulses IP6 with the measured detector current 16 and for determining the property EG (e.g. dose power) of the ionizing radiation IS on the basis of the comparison.

In alternative exemplary embodiments, the determining device need not or may not be configured for comparing and for determining on the basis of the comparison.

The apparatus 1 further comprises an operating point setting device 10 having a reference source 11, which emits ionizing reference radiation ISR, as shown in FIGS. 1 and 3.

In detail, the operating point setting device 10 is configured for independently setting the voltage source 5, in particular the voltage U5, to an operating point voltage value U5R in such a way that the detector current 16 measured by the ionizing reference radiation ISR reaches a predefined reference current volume I6R, in particular during operation with gas gain, in particular during proportional range operation, as shown in FIG. 4.

In addition, the operating point setting device 10 is configured for independently setting the voltage source 5, in particular the voltage U5, to an, in particular the, operating point voltage value U5R in such a way that a property of a, in particular the, spectrum SP of the heights H6 of the detector current pulses IP6, said heights being measured by the ionizing reference radiation, reaches a predefined reference spectrum value, in particular during operation with gas gain, in particular during proportional range operation, as shown in FIG. 5.

In detail, FIG. 5 qualitatively shows the pulse height spectrum SP that results e.g. with a radionuclide with the correct operating point voltage value U5. In the exemplary embodiment shown, for the purpose of correctly setting the operating point voltage value U5R, the voltage U5 is altered or varied such that the spectrum components A1 and A2, in particular the integrals over parts of the spectrum SP, assuming that the spectrum form is always the same, yield a previously defined ratio, the predefined reference spectrum value EGSR: A2/(A1+A2)=constant=EGS. The threshold TH1 separates undesired interference and noise components (below A1). The energetically higher threshold TH2 separates the upper signal component A2. In alternative exemplary embodiments, the property of the spectrum can be a position of an unambiguous maximum in the spectrum, the threshold TH2 in FIG. 5.

In alternative exemplary embodiments, it may be sufficient if the operating point setting device can be configured either for setting in such a way that the measured ionization current and/or signal current reach(es) the predefined reference current value, or for setting in such a way that the property of the spectrum of the measured heights of the ionization current pulses and/or signal current pulses reaches the predefined reference spectrum value.

Moreover, the apparatus 1 comprises a settable electronic amplification device 15′, 15″, as shown in FIG. 3. The electronic amplification device 15′, 15″ is configured for amplifying the detector current 16 and/or the detector current pulses IP6 with a settable gain value VW. The operating point setting device 10 is configured for independently setting the amplification device 15′, 15″ to a first gain value VWa and for independently setting the voltage source 5, in particular the voltage value U52a, to a first operating point voltage value U5Ra for attaining the reference current value I6R and/or the reference spectrum value EGSR in the case of the first gain value VWa. Furthermore, the operating point setting device 10 is configured for independently setting the amplification device 15′, 15″ to a second gain value VWb, higher than the first, and for independently setting the voltage source 5, in particular the voltage value U52b, to a second operating point voltage value U5Rb, lower than the first, for attaining the reference current value I6R and/or the reference spectrum value EGSR in the case of the second gain value VWb.

In particular, the first gain value VWa is lower than the second gain value VWb by a factor of 5-20, in particular 10. In alternative exemplary embodiments, there may be at least three gain values and correspondingly at least three operating point voltage values.

In detail the following equation can hold true: (primary ionization current with reference source)×(gas gain)×(electronic gain)=reference current value. Generally, the following equation can hold true: (ionization current)×(gas gain)×(electronic gain)=detector current. The same can correspondingly hold true in the case of the spectrum of the measured heights of the detector current pulses, in particular wherein, instead of the current, it is possible to use for example the integral over the spectrum with regard to the pulse heights.

Furthermore, the reference source 11 comprises for example Na-22 and/or Fe-55 and/or Cl-36, as shown in FIG. 1.

Moreover, the apparatus 1 is configured for a defined detector-reference source geometry. In detail, the detector 2 comprises a probe 22 comprising the cathode device 3, the anode device 4 and the counting gas ZG. The apparatus 1 comprises a housing 20 having an opening 21 for inserting the probe 22. The reference source 11 is arranged spatially behind the opening 21.

After the probe 22 has been removed or withdrawn from the opening 21, the actual or normal measurement, as described above, can begin or be continued.

In detail, the apparatus 1 comprises a microcontroller, wherein the microcontroller comprises a part of the operating mode setting device 7, a part of the determining device 8 and a part of the operating point setting device 10. In other words, the operating mode setting device 7, the determining device 8 and the operating point setting device 10 are accommodated besides other setting devices in the microcontroller device.

The apparatus 1 further comprises a drivable alarm signal output device 12. The alarm signal output device 12 is configured for outputting an, in particular acoustic and/or optical, alarm signal AS. The operating mode setting device 7 is configured for independently driving the alarm signal output device 12 for outputting the alarm signal AS depending on the measured detector current 16.

Furthermore, the cathode device 3 is configured to be at ground potential EGND during operation, or the cathode device 3 is at ground potential EGND during operation, as shown in FIG. 3. The anode device 4 is configured to be at a positive potential PLUS relative to ground potential EGND during operation, or the anode device 4 is at the positive potential PLUS during operation.

In detail, the circuit parts enclosed by a dashed border are at the positive potential PLUS during operation. In particular, the detector current 16 is tapped off at the positive potential level. The decoupling of the ionization current pulses IP6 at the positive potential level is effected by way of a capacitive coupling.

Moreover, the cathode device 3 partly or completely consists of carbon fibers CF.

In detail, the cathode device 3 has a wall thickness T3 of 0.1 millimeter (mm) to 2 mm, in particular 1.5 mm.

In one development of the invention, the detector comprises, in particular either, a cylindrical counting tube 13, as shown in FIG. 2a, or a large-area counter 14, as shown in FIG. 2b.

In detail, the cathode device 3 spatially surrounds the anode device 4.

The cylindrical counting tube 13 further comprises just a single anode wire 4. The large-area counter 14 comprises a plurality of anode wires 4, in particular electrically connected in parallel and arranged such that they run parallel. In particular, the anode wire/anode wires 4 has/have, in particular in each case, a diameter D4 of 40 micrometers (μm) to 80 μm, in particular 60 μm. Additionally or alternatively, the anode wire/anode wires 4 consists/consist, in particular in each case, partly or completely of tungsten.

In detail, the cylindrical counting tube 13 is closed at both end sides. Furthermore, in the case of the cylindrical counting tube 13, the cathode device 3 is configured in a cylindrical fashion. In particular, the cylindrical counting tube 13 or the cathode device 3 has a diameter D3 of 15 mm to 35 mm, in particular 25 mm. Additionally or alternatively, the cathode device 13 is the tube wall. The anode wire 4 is situated or is clamped in the longitudinal axis or center axis of the cylinder and is led out of the counting tube 13 at one end through an insulator, in particular ceramic. Isobutane, for example, is suitable as counting gas ZG.

In particular, the cylindrical counting tube 13 can be used for dose power measurement for gamma and/or X-ray radiation.

In detail, the apparatus 1 for dose power measurement for gamma and/or X-ray radiation is configured to be operated in all four operating modes.

In detail, the large-area counter 14 comprises three planes, a middle one of the three planes being shown in FIG. 2b. A front one of the three planes is formed by a very thin window composed of metallized plastic film, in particular for a gas flow counter, or titanium, in particular for a gastight counter having a permanent gas filling. The inner side of the window is grounded. The middle one of the three planes is formed by the plurality of anode wires 4. A rear one of the three planes is formed by an electrically conductive back wall, which is likewise grounded. In particular, the active detector area is hundreds of square centimeters.

In particular, the large-area counter 14 can be used for measuring radioactive contaminations of surfaces or persons, for example with hand-foot monitors or whole-body monitors.

In detail, the apparatus 3 in accordance with FIG. 2b for surface contamination measurement is configured to be operated in the operating mode B3, in particular single-pulse counting. In addition, the apparatus 3 for contamination measurement is configured to be changed over from the operating mode B3 to the operating mode(s) B1 or B2 and/or to output the alarm signal AS in the event of the current limit value being reached or exceeded by the measured detector current 16.

In particular, an operating point voltage setting, as described above, need not or may not be carried out. The operating point setting is carried out here by way of the recording of a plateau curve.

As made clear by the exemplary embodiments shown and explained above, the invention provides an advantageous apparatus for measuring ionizing radiation which has improved properties compared with the prior art, in particular enables a simple and thus cost-effective construction and at the same time, in particular flexible and/or safe, operation depending on the ionizing radiation.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for measuring ionizing radiation, comprising:
(a) a detector comprising:
a cathode,
an anode,
a counting gas between the cathode and the anode for generating gas ionization by ionizing radiation,
a voltage source for applying a voltage between the cathode and the anode, and
a current measuring device for measuring a detector current between the cathode and the anode, said detector current being generated in the counting gas by the ionizing radiation; and
(b) a setting device,
wherein the setting device is configured for independently setting the apparatus into different operating modes depending on the measured detector current, and/or
wherein the setting device is configured for independently setting the apparatus into different measurement ranges depending on the measured detector current.

2. The apparatus according to claim 1, wherein
the setting device is configured to set the different operating modes and/or the different measurement ranges depending on whether the measured detector current exceeds a first threshold value or falls below a second threshold value.

3. The apparatus according to claim 1, wherein
the different operating modes comprise a first operating mode, in which the detector operates with gas gain, and a second operating mode, in which the detector operates without gas gain.

4. The apparatus according to claim 3, wherein
in the first operating mode, a first measurement range with high gas gain is settable and further measurement ranges with lower gas gain are settable.

5. The apparatus according to claim 1, wherein
switching between different operating modes and/or switching between different measurement ranges are brought about by alteration of the applied voltage between the cathode and the anode.

6. The apparatus according to claim 1, further comprising at least one of:
(c) a measurement variable determining device configured to determine a measurement variable on the basis of the measured detector current, and
(d) a measurement variable determining device configured to determine a measurement variable, wherein the setting device is configured to monitor the process of determining the measurement variable depending on the measured detector current.

7. The apparatus according to claim 3, wherein
the different operating modes comprise a third operating mode, in which the detector operates with gas gain and a measurement variable is determined on the basis of a counting rate of pulses generated by way of the detector.

8. The apparatus according to claim 7, wherein
the different operating modes comprise a fourth operating mode, in which the detector operates with gas gain and a measurement variable is determined on the basis of a pulse height spectrum of pulses generated by way of the detector.

9. The apparatus according to claim 1, further comprising:
an operating point setting device having a reference source emitting ionizing reference radiation, wherein
the operating point setting device is configured to set the applied voltage between the cathode and the anode to an operating point voltage value in such a way that:
(i) the detector current measured by the ionizing reference radiation reaches a predefined reference current value, and/or
(ii) a property of a pulse height spectrum of pulses generated by way of the detector, said pulse height spectrum being measured by the ionizing reference radiation, reaches a predefined reference spectrum value.

10. The apparatus according to claim 9, further comprising:
a settable electronic amplification device configured to effect electronic amplification with an electronic gain value, wherein
the operating point setting device for calibrating one or more measurement ranges in the proportional range is configured to:
(i) set the electronic amplification with a first electronic gain value and set the applied voltage to a first operating point voltage value for a first measurement range with high gas gain in such a way that the measured detector current reaches the reference current value and/or a suitable property of a reference spectrum is attained, and
(ii) set the electronic amplification to further higher electronic gain values relative to the first and set the applied voltages to further lower operating point voltage values relative to the first for further measurement ranges with lower gas gain in such a way that the measured detector current reaches the reference current value and/or a suitable property of a reference spectrum is attained.

11. The apparatus according to claim 10, wherein
the reference source comprises sodium-22, iron 55, and/or chlorine 36.

12. The apparatus according to claim 1, further comprising:
a controllable alarm signal output device configured to output an alarm signal, wherein
the setting device is configured to control the outputting of the alarm signal depending on the measured detector current.

13. The apparatus according to claim 1, wherein
the cathode is configured to be at ground potential during operation, and
the anode is configured to be at a positive potential relative to ground potential during operation.

14. The apparatus according to claim 3, wherein
in the second operating mode, a counting wire is the cathode and a counting tube wall is the anode.

15. The apparatus according to claim 1, wherein
the cathode partly or completely is made of carbon fibers, and/or
the detector comprises a cylindrical counting tube or a large-area counter.
